(19) United States
(12) Patent Application Publication
(10) Pub. No.: US 2017/0197334 A1
(43) Pub. Date: Jul. 13, 2017

(54) DOUBLE MOLDED PULP MOLDING MACHINE

(71) Applicant: GOLDEN ARROW PRIINTING CO.,LTD., New Taipei City (TW)

(72) Inventors: Chien-Kuan Kuo, New Taipei City (TW); Chun-Huang Huang, New Taipei City (TW)

(21) Appl. No.: 14/994,139

(22) Filed: Jan. 12, 2016

(51) Int. Cl. B29C 33/20

(52) U.S. Cl. CPC B29C 33/202; B29L 2031/00

(57) ABSTRACT

A pulp molding machine includes a frame, a longitudinal mechanism and a transversal mechanism, a forming and carrying module, and a pair of heat pressing molds. The frame has a longitudinal section and a transversal section where a longitudinal mechanism and a transversal mechanism are disposed correspondingly. The forming and carrying module includes a carrying upper mold and a forming lower mold being capable of lifting in the slurry tank and clamping and delivering with the carrying upper mold. The heat pressing molds includes a heat pressing upper mold and a heat pressing lower mold. The time of the forming lower mold delivers productions to the heat pressing lower molds is close to or the same as the total time of the heat pressing molds finish heat pressing and drying.

### BACKGROUND OF THE INVENTION

Field of the Invention

The present invention generally relates to a pulp molding machine and, in particular to a double molded pulp molding machine.

Description of Prior Art

Currently existing pulp (paper pulp) molding machine includes a frame, a slurry tank, and a plural of molds disposed in the frame. After being collected and forming in the slurry tank, a wet molding pulp product is molded and formed. Then the wet molding pulp product is clamped and dried to form a paper pulp product.

However, now pulp molding machines have following shortcomings: firstly, the frame is assembled in segments and the machine is deposed in a line, so that a grounding area of the frame is a rectangle area and unstable. Thus vibrations will happen during operation that affects the clamping of moldings, and a damage to the moldings will be caused when the moldings are clamped misalignedly. Secondly, the time for heat drying the wet molding pulp product is longer than the time for collecting wet molding pulp in the slurry tank to form the wet molding pulp product. Hence, the molding cannot proceed to another molding pulp collecting process until the molding is completely dried. Therefore, time is wasted on waiting in manufacturing and the productivity will be affected. Thirdly, the frame is made by assembling which causes the overall structure unstable, and drying the wet molding pulp product is easily to cause deformation to the frame as well, so that the tolerance of the moldings will be affected. As a result, the productivity will be lowered.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a double molded pulp molding machine that a frame can be stood firmly on the ground without vibration and will not affect the clamping effect of the molds. Further, the sinking and forming processes do not need to be waited for the heat pressing and drying processes. Thus the productivity can be improved.

In order to achieve the object mentioned above, the present invention provides a double molded pulp molding machine including a frame, a longitudinal mechanism, a transversal mechanism, a forming and carrying module and a pair of heat pressing molds. The frame has a moving space, a longitudinal section and a transversal section which are connected to each other and overlapped in longitudinal and transversal directions, and the frame provides with a slurry tank in the longitudinal section corresponding to the moving space. The longitudinal mechanism is disposed in the longitudinal section and corresponded to a top wall of the moving space. The forming and carrying module includes a carrying upper mold driven by the longitudinal mechanism and a forming lower mold being capable of lifting in the slurry tank and clamping and delivering with the carrying upper mold. The transversal mechanism is disposed in the transversal section and corresponded to a bottom wall of the moving space. Each of the heat pressing molds includes a heat pressing upper mold and a heat pressing lower mold driven by the transversal mechanism. The carrying upper mold is capable of clamping and delivering with each heat pressing lower mold, and the heat pressing upper mold is capable of clamping and heat pressing with the heat pressing lower mold; wherein the time of the forming lower mold delivers productions to the carrying upper module repeatedly and then the carrying upper module delivers the productions to each of the heat pressing lower molds that is close to or the same as the total time of the heat pressing molds finish heat pressing and drying.

Comparing to the prior art, the present invention has the following effects. In the present invention, the frame can stand firmly on the ground and will not shake during the operation of the pulp molding machine, thus the molds can be prevented from damages. Furthermore, the sinking and forming processes do not have to be waited for the heat pressing and drying processes. Hence the productivity will be improved.

### BRIEF DESCRIPTION OF DRAWING

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a front schematic view of the present invention before the operation.

FIG. 2 is a top schematic view of the present invention before the operation.

FIG. 3 is another top schematic view of the present invention before the operation.

FIG. 4 is another front schematic view of the present invention before the operation, showing a forming lower mold in the slurry tank.

FIG. 5 is a front schematic view of the present invention showing a forming lower mold lifted and clamped with a carrying upper mold.

FIG. 6 is a front schematic view of the present invention showing the forming lower mold sink again in the slurry tank.

FIG. 7 is a top schematic view of the present invention showing the carrying upper mold moved forward.

FIG. 8 is a front schematic view of the present invention showing the carrying upper mold lowered and clamped with the right heat pressing lower mold.

FIG. 9 is a top schematic view of the present invention showing the carrying upper mold moved backward, and the left heat pressing mold and right heat pressing mold are moved right simultaneously.

FIG. 10 is a front schematic view of the present invention showing the forming lower mold lifted and clamped with the carrying upper mold, and the right heat pressing molds are clamped.

FIG. 11 is a top schematic view of the present invention showing the carrying upper mold moved forward again.

FIG. 12 is a front schematic view of the present invention showing the carrying upper mold lowered again and clamped with the left heat pressing lower mold.

FIG. 13 is a top schematic view of the present invention showing the carrying upper mold lifted.

FIG. 14 is a top schematic view of the present invention showing the left heat pressing lower mold moved left and the carrying upper mold moved backward.

FIG. 15 is a front schematic view of the present invention showing the left heat pressing upper mold lowered and clamped with the left heat pressing lower mold for heat pressing, and the right heat pressing upper mold lifted.

FIG. 16 is a top schematic view of the present invention showing the right tray entering underneath the right heat pressing upper mold.

FIG. 17 is a front schematic view of the present invention showing the right tray entering the underneath of the right heat pressing upper mold.

FIG. 18 is a front schematic view of the present invention showing the right heat pressing upper mold released and fallen on the right tray, and the forming lower mold is lifted and clamped with the carrying upper mold.

### DETAILED DESCRIPTION OF THE PREFERRED EMBODIMENTS

In cooperation with attached drawings, the technical contents and detailed description of the invention are described thereinafter according to a number of preferable embodiments, being not used to limit its executing scope. Any equivalent variation and modification made according to appended claims is all covered by the claims claimed by the present invention.

The present invention provides a double molded pulp molding machine that is one sinking-forming process with two (or two more) heat pressing and drying processes. Further, the paper pulp products are discharged (two output sources) separately after the heat pressing and drying process. Thus a result of double outputs will be reached without waiting.

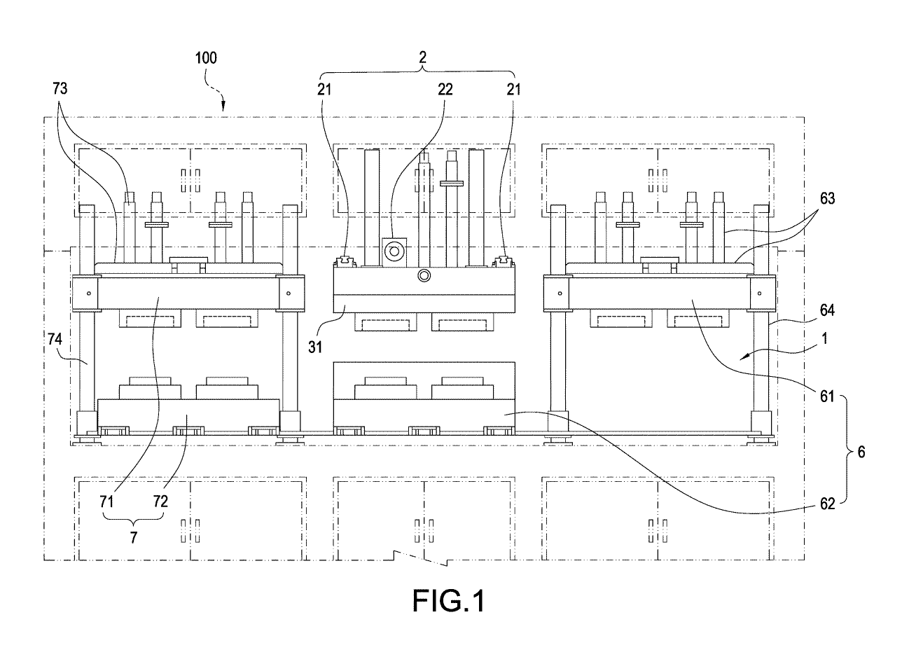

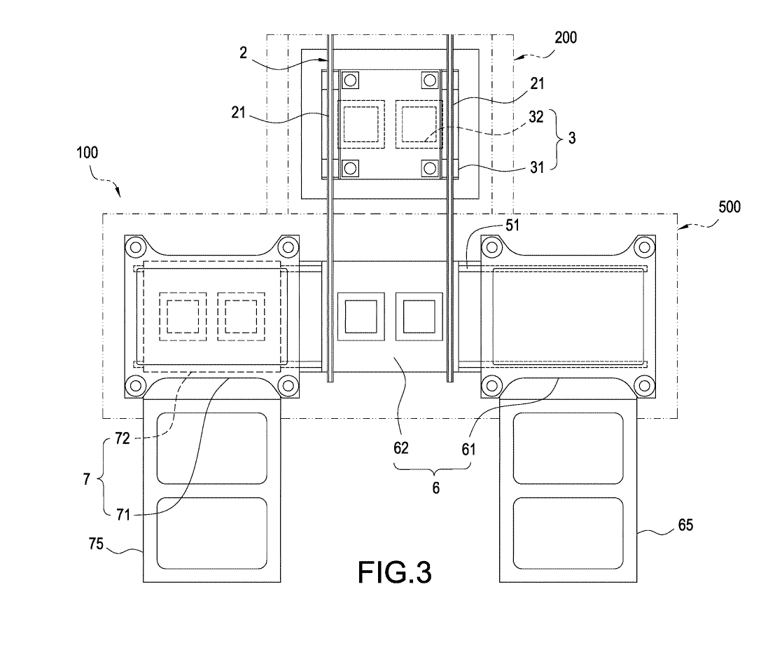

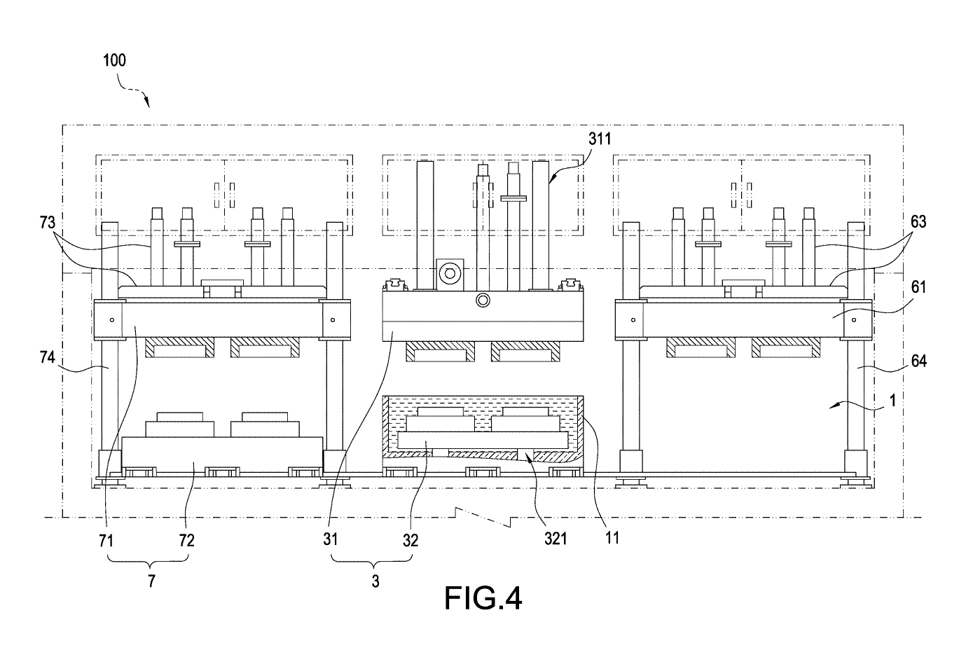

Please refer to FIG. 1 to FIG. 4, the pulp molding machine of the present invention includes a frame 100, a longitudinal mechanism 2, a forming and carrying module 3, a transversal mechanism 5 and a pair of heat pressing molds 6,7.

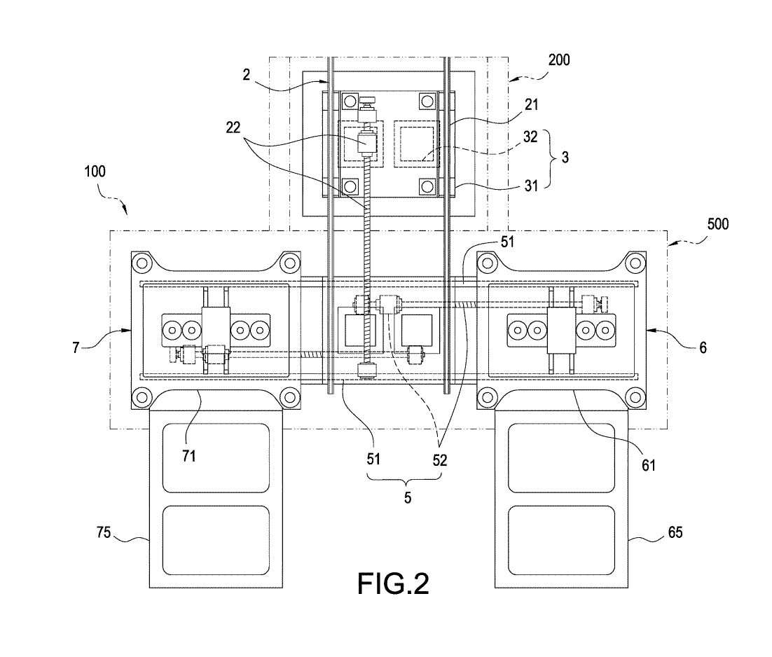

The frame 100 can be formed as an integral body and has a moving space 1 for an activity of the forming and carrying module 3. The frame 100 includes a longitudinal section 200 and a transversal section 500 which are connected to each other and overlapped in longitudinal and transversal directions. Preferably, the longitudinal section 200 and the transversal section 500 are configured in a T-shaped (see FIG. 2) such that the frame 100 can be stood firmly on the ground in a three coplanar manner, wherein the frame 100 is provided with a slurry tank 11 disposed in the longitudinal section 200 corresponding to the moving space 1.

The longitudinal mechanism 2 is disposed in the longitudinal section 200 and corresponded to a top wall of the moving space 1. Preferably, the longitudinal mechanism 2 includes a pair of longitudinal rails 21 and at least one longitudinal lead screw 22 disposed in the longitudinal section 200 of the frame 100, and the longitudinal rails 21 and the longitudinal lead screw 22 are provided in a longitudinal direction.

The transversal mechanism 5 is disposed in the transversal section 500 and corresponded to a bottom wall of the moving space 1, wherein the top wall and the bottom wall are facing each other. Preferably, the transversal mechanism 5 includes a pair of transversal rails 51 and at least one transversal lead screw 52 disposed in the transversal section 500, and the transversal rails 51 and the transversal lead screw 52 are provided in a transversal direction. As shown in FIG. 2, one end of the longitudinal section 2 is connected between the two ends of the transversal section 500 in overlapping manner.

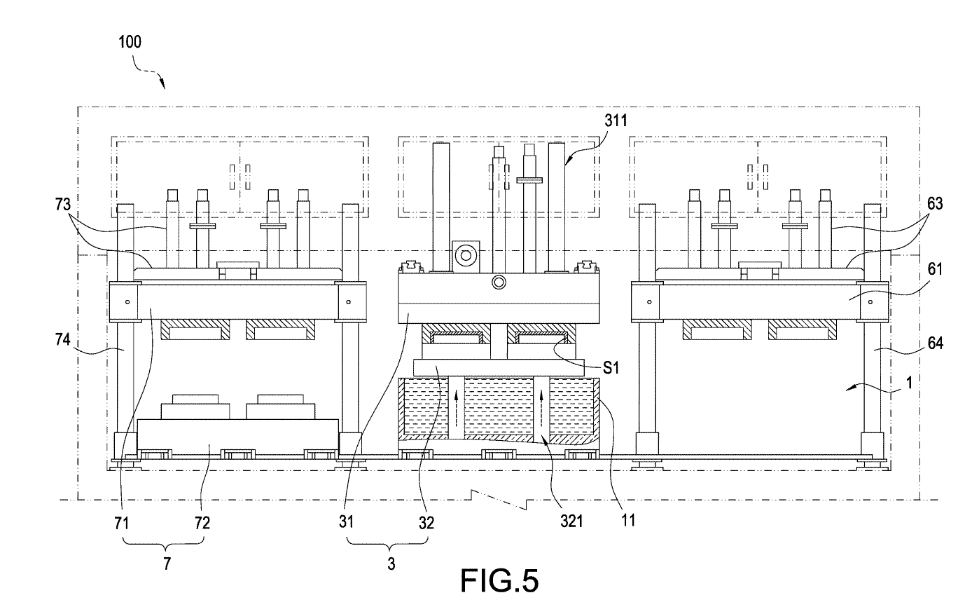

The forming and carrying module 3 includes a carrying upper mold 31 driven by the longitudinal mechanism 2 and a forming lower mold 32 being capable of lifting in the slurry tank 11 and clamping and delivering with the carrying upper mold 31. The forming lower mold 32 is provided with a forming lifting mechanism 321 for controlling the lifting of the forming lower mold 32 in the slurry tank 11, and a wet pulp molding product will be formed when the forming lower mold 32 is lifted and clamped with the carrying upper mold 31. With the carrying upper mold 31 is vacuumed for sucking the wet pulp molding product (first wet pulp molding product S1, see FIG. 5) for the delivering, wherein the carrying upper mold 31 is provided with a carrying lifting mechanism 311 for controlling the lifting of the carrying upper mold 31, and the wet pulp molding product will be delivered (to a heat pressing lower mold) when the carrying upper mold 31 is lowered and clamping and delivering with the heat pressing lower mold.

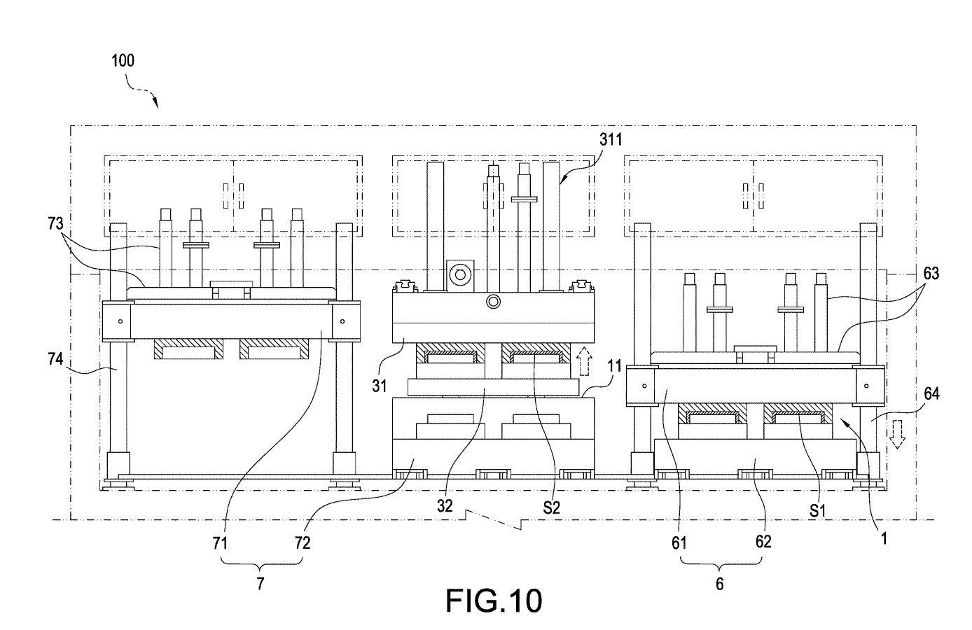

Each of the pair of heat pressing molds 6, 7 includes a heat pressing upper mold 61 and a heat pressing lower mold 62, 72 driven by the transversal mechanism 5. The carrying upper mold 31 is capable of clamping and delivering with each heat pressing lower mold 62, 72, and the heat pressing upper molds 61, 71 are used to clamp and heat pressing with the heat pressing lower molds 62, 72, wherein the vacuum suction force can be removed for delivering the wet pulp molding product to the heat pressing lower molds 62, 72. Each heat pressing upper mold 61, 71 can be vacuumed for sucking the wet pulp molding product (first wet pulp molding product S1 and the second wet pulp molding product S2, see FIG. 10) from the heat pressing lower mold 62, 72 and delivering (the wet pulp molding product) to the heat pressing upper mold 61, 71.

Furthermore, the heat pressing upper mold 61, 71 is further provided with a heat pressing lifting mechanism 63, 73, and the heat pressing upper mold 61, 71 is driven by the heat pressing lifting mechanism 63, 73 for clamping with the heat pressing lower mold 62, 72 respectively. Besides, the heat pressing upper mold 61, 71 will be heat pressed while clamping with the heat pressing lower mold 62, 72 for heat drying the wet pulp molding product.

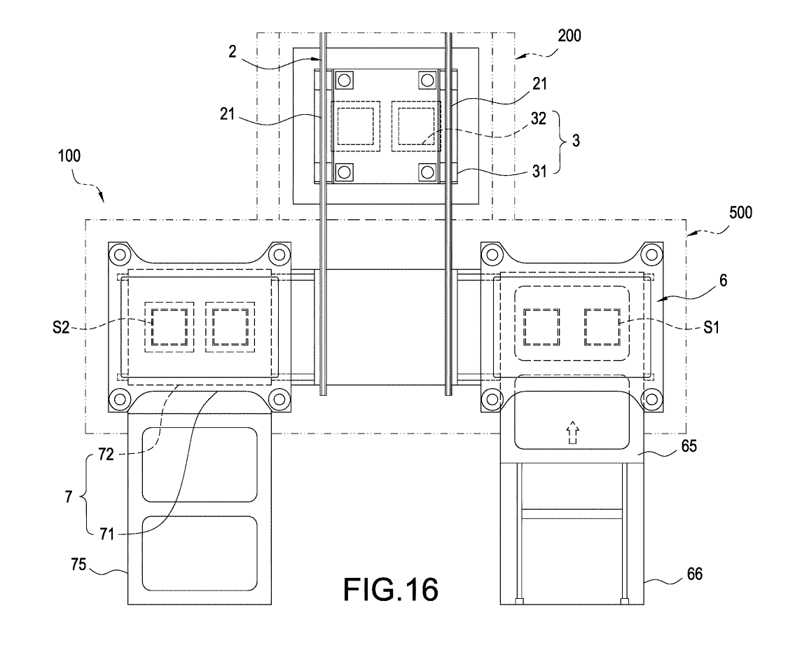

As shown in FIG. 16 and referring with FIG. 1 to FIG. 4, the present invention preferably further includes a pair of guiding racks 66 (another guiding rack is not shown in the figure) and a pair of trays 65, 75. Two guiding racks 66 are disposed separately in the transversal section 500 corresponding to the locations of the heat pressing molds 6, 7, and two trays 65, 75 are disposed separately and driven by the guiding racks 66, so that each guiding rack 66 can guide each of the trays 65, 75 respectively and go back and forth under the heat pressing upper molds 61, 71 in a longitudinal direction. Therefore, the formed paper pulp products will be fallen on the trays 65, 75 and discharged.

Please refer to FIG. 5, the forming lower mold 32 is lifted by the driving of the forming lifting mechanism 321 and clamped with the carrying upper mold 31 for forming a first wet pulp molding product S1.

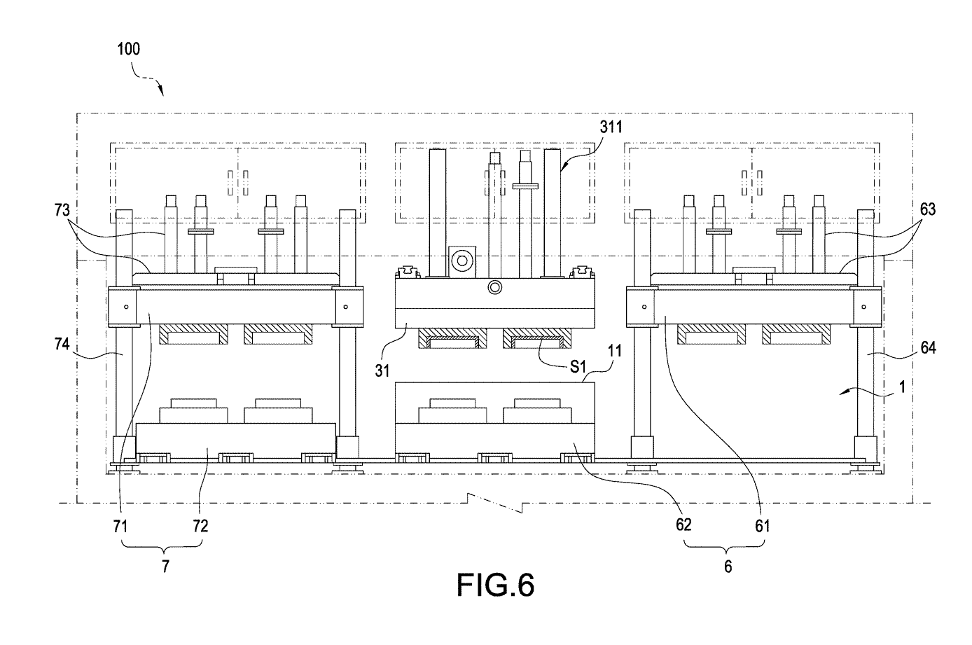

With referring to FIG. 6, the forming lower mold 32 is lowered by the driving of the forming lifting mechanism 321 and sunk back in the slurry tank 11; meanwhile, the carrying upper mold 31 sucks the first wet pulp molding product S1 by vacuuming to finish the delivering process.

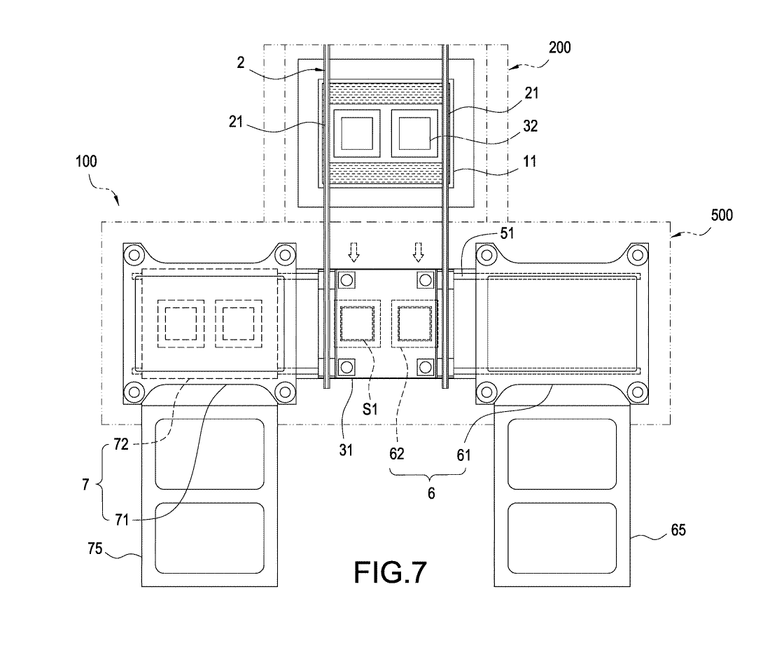

As shown is FIG. 7, the carrying upper mold 31 is driven by the longitudinal mechanism 2 and moved forward to the middle of the transversal section 500. At this time, with referring to FIG. 6, the right heat pressing lower mold 62 is already moved left to the middle of the transversal section 500 that can make the forwarded carrying upper mold 31 just located above the heat pressing lower mold 62.

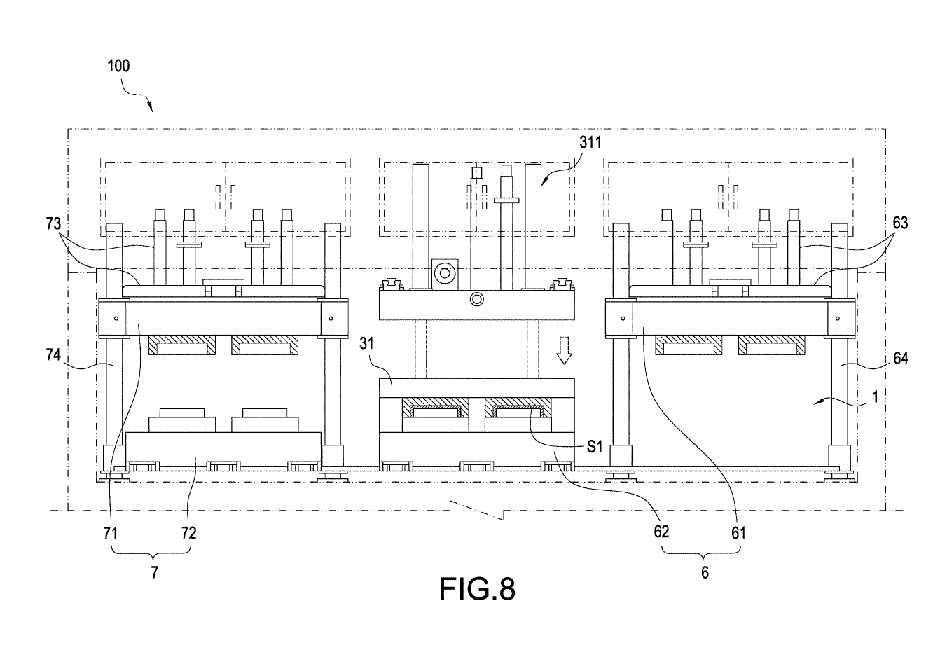

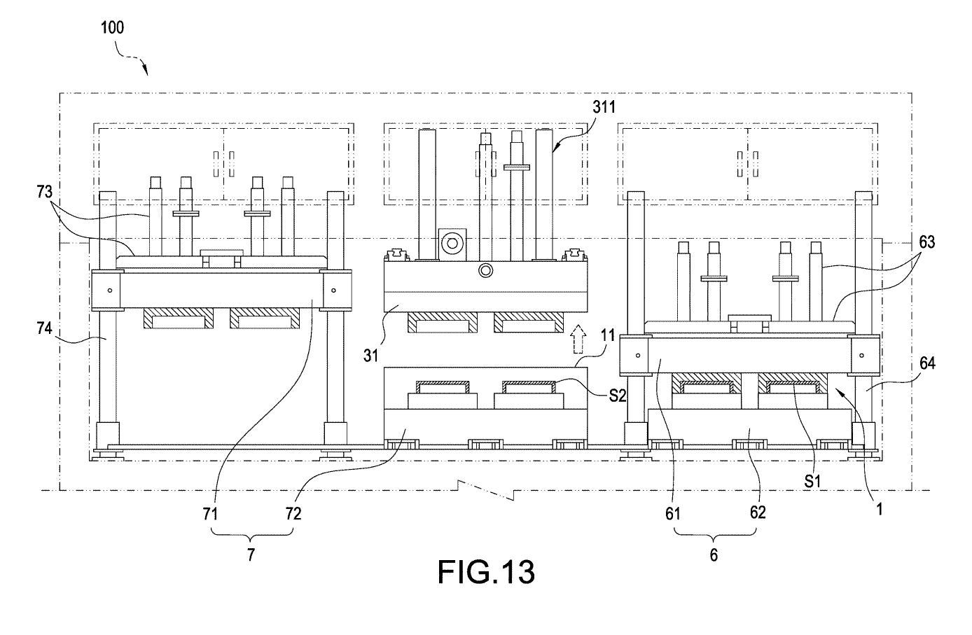

Please refer to FIG. 8, the carrying upper mold 31 is lowered by the driving of the carrying lifting mechanism 311, and the carrying upper mold 31 is clamped and delivered with the heat pressing lower mold 62. After delivering, the carrying upper mold 31 is lifted by the driving of the carrying lifting mechanism 311 (not shown in FIG. 8, but shown in FIG. 13).

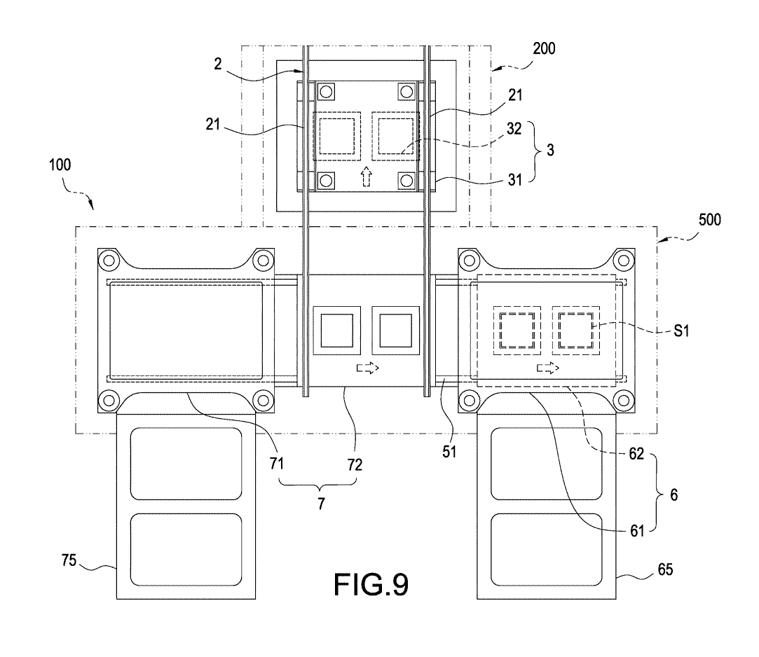

As shown in FIG. 9, the carrying upper mold 31 is driven by the longitudinal mechanism 2 and moved backward above the forming lower mold 32; meanwhile, the heat pressing lower mold 62, 72 is driven by the transversal mechanism 5 and moved right together. Thus the heat pressing lower mold 62 is moved below the heat pressing upper molds 61, and the heat pressing lower mold 72 is moved in the middle of the transversal section 500.

With referring to FIG. 10, the forming lower mold 32 is lifted again by the driving of the forming lifting mechanism 321 to clamp with the carrying upper mold 31 for forming a second wet pulp molding product S2. The carrying upper mold 31 sucks the second wet pulp molding product S2 by vacuum, so that the forming lower mold 32 can deliver the second wet pulp molding product S2 to the carrying upper mold 31; meanwhile, the heat pressing upper mold 61 is lowered by the driving of the heat pressing lifting mechanism 63, and the heat pressing upper mold is clamped with the heat pressing lower mold 62 for heat drying the first wet pulp molding product S1.

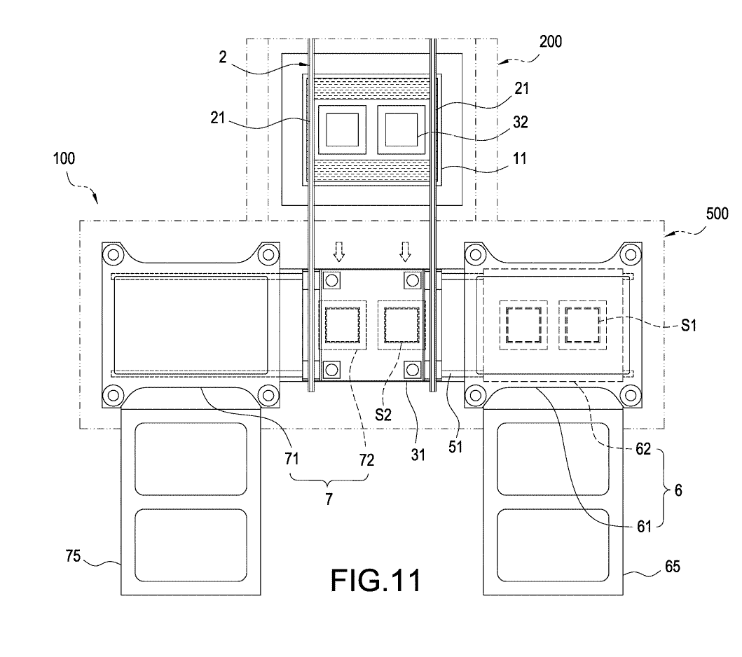

As shown in FIG. 11, the carrying upper mold 31 is moved forward to the middle of the transversal section 500 by the driving of the longitudinal mechanism 2 again; at the same time, the first wet pulp molding product S1 is still in heat drying by the heat pressing mold 6.

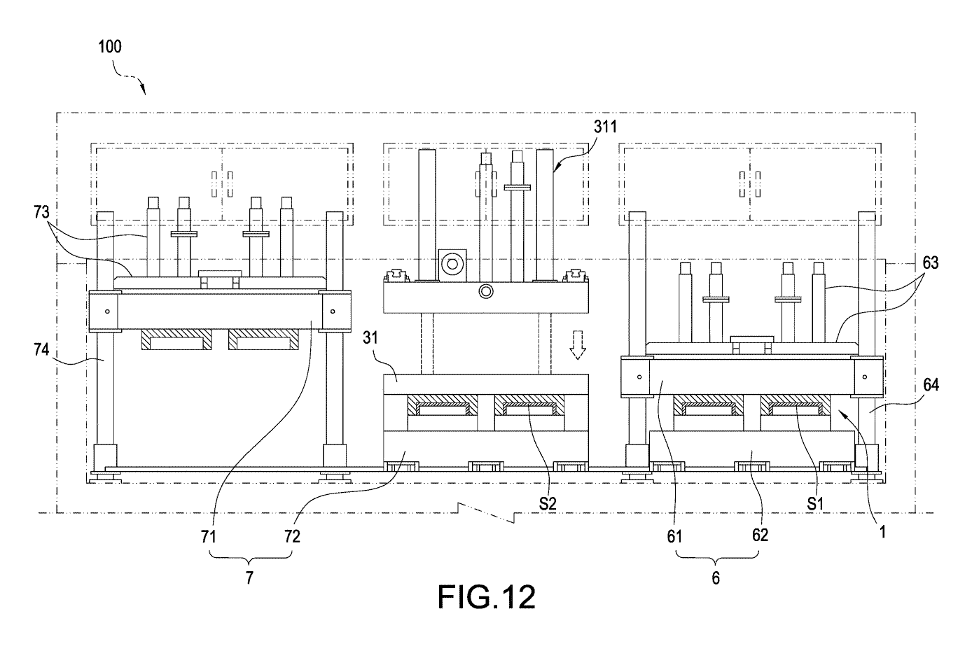

With referring to FIG. 12, the carrying upper mold 31 is lowered by the driving of the carrying lifting mechanism 311 again, and the carrying upper mold 31 is clamped with the heat pressing lower mold 72, and the second wet pulp molding product S2 is delivered to the heat pressing lower mold 72; in the meantime, the first wet pulp molding product S1 is still in heat drying by the heat pressing mold 6.

Please refer to FIG. 13, the forming upper mold 31 is lifted by the driving of the carrying lifting mechanism 311 again; meanwhile, the first wet pulp molding product S1 is still in heat drying by the heat pressing mold 6.

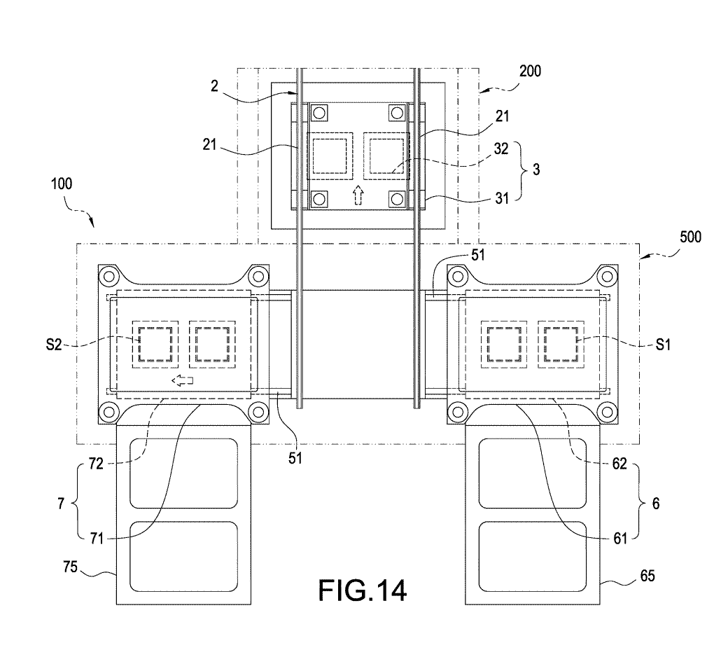

As shown in FIG. 14, the carrying upper mold 31 is driven by the longitudinal mechanism 2 again and moved backward above the forming lower mold 32; meanwhile, the heat pressing lower mold 72 is driven by the transversal mechanism 5 and moved left below the heat pressing upper mold 71. At this moment, the first wet pulp molding product S1 is still in heat drying by the heat pressing mold 6.

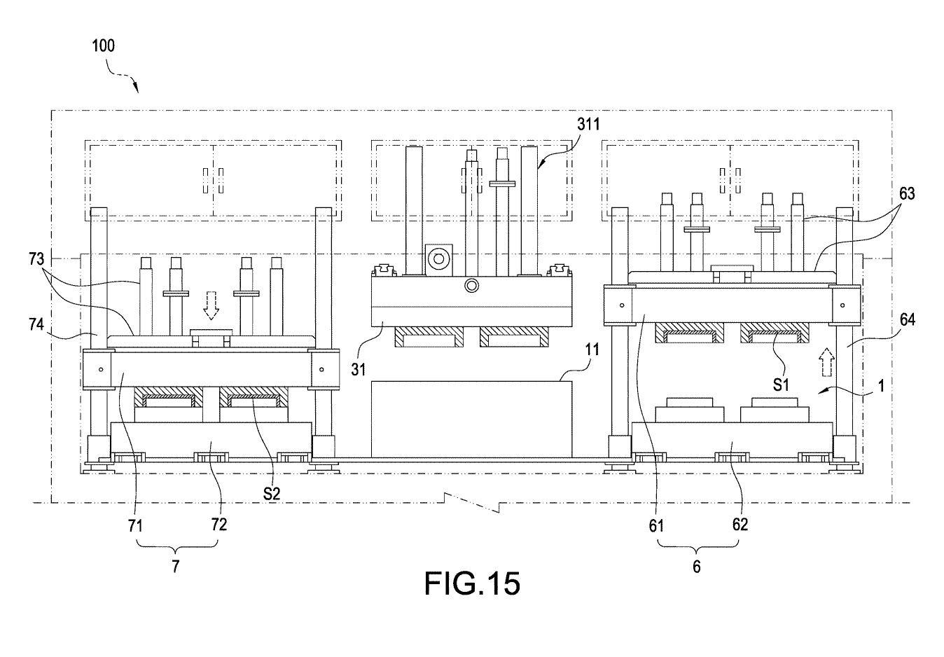

With referring to FIG. 15, the heat pressing upper mold 71 is lowered by the driving of the heat pressing lifting mechanism 73, and the heat pressing upper mold 71 is clamped with the heat pressing lower mold 72, and the second wet pulp molding product S2 is in heating drying by the heat pressing lower mold 72; in the meantime, the heat pressing mold 6 has finished the heat drying process, therefore, the heat pressing upper mold 61 is lifted by the driving of the heat pressing lifting mechanism 63, and the first wet pulp molding product S1 dried and become a paper pulp product is sucked by the vacuum.

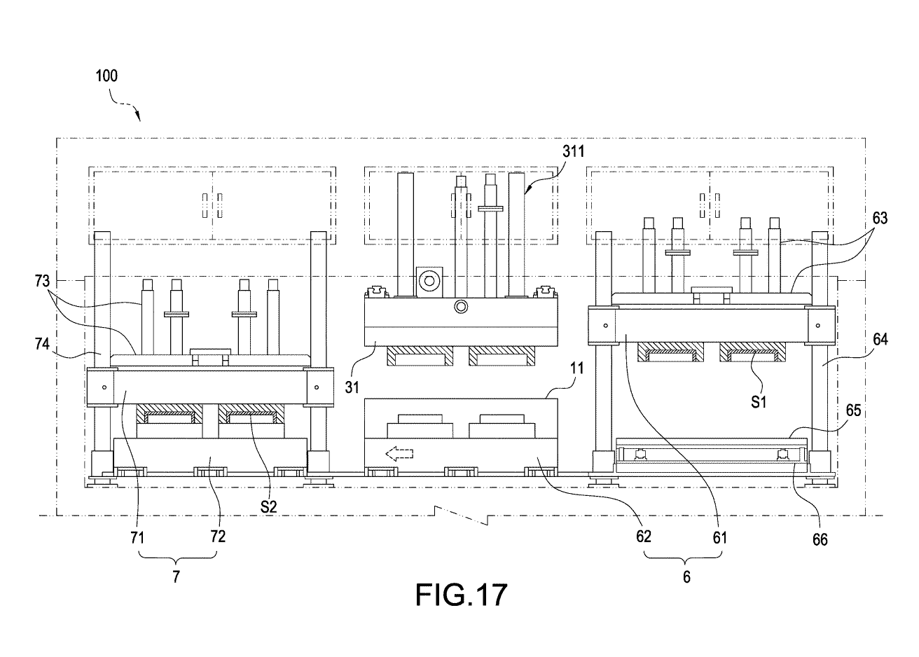

Please refer to FIG. 16 and FIG. 17, the heat pressing lower mold 62 driven by the transversal mechanism 5 is moved left to the middle of the transversal section 500. The tray 65 driven by the guiding racks 66 is moved below the heat pressing upper mold 61. In the meantime, the second wet pulp molding product S2 is still in heat drying by the heat pressing mold 7.

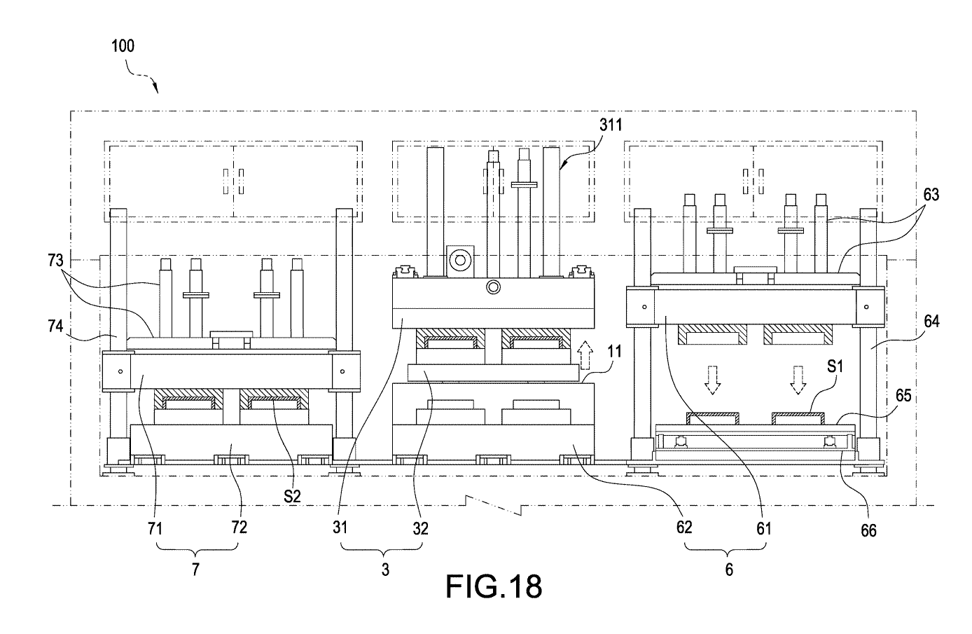

As shown in FIG. 18, the first wet pulp molding product S1 dried and formed as a paper pulp product falls on the tray 65 and discharged by removing the vacuum suction. At this time, the forming lower mold 32 is lifted by the driving of the forming lifting mechanism 321 and clamped with the carrying upper mold 31 for forming another first wet pulp molding product. Then the carrying upper mold 31 will be moved forward and lowered as shown in FIG. 7 and FIG. 8, so that another first wet pulp molding product will be delivered to the heat pressing lower mold 62. Afterward, paper pulp products will be produced in double molded (discharged by two trays 65, 75 in two ends of the transversal section 500) in a sequence and motion referring to FIG. 9 to FIG. 18 repeatedly.

Briefly, the time of the forming lower mold 32 delivers the wet pulp molding products to the carrying upper mold 31 twice add the time of the carrying upper mold 31 delivers the wet pulp molding products to each of the two heat pressing lower molds 62, 72 once separately that is close to or the same as the total time of the two heat pressing molds 6, 7 finish heat pressing and drying. Thus the sinking and forming processes do not have to wait for the heat pressing and drying processes.

Moreover, the heat pressing molds 6, 7 are preferably disposed in two ends of the transversal section 500 separately, and the longitudinal section 200 is connected between the two ends of the transversal section 500 in overlapping manner. Besides, the displacement of the heat pressing lifting mechanism 63, 73 is driven by two guiding rods 64, 74 of the frame 100.

In conclusion, the present invention comparing with the prior art has the following effects. The frame 100 can be stood firmly on the ground in a three coplanar manner because of the frame 100 having a longitudinal section 200 and a transversal section 500 which are connected to each other and overlapped in longitudinal and transversal directions. Therefore, the frame 100 of the pulp molding machine will not shake during the operation, and the molds without vibration will not be damaged during the clamping. With the specific structures and particular arrangement, the sinking and forming processes do not have to wait for the heat pressing and drying processes. Hence the productivity will not be affected.

Furthermore, the present invention also has other effects. The frame 100 is formed as an integral body that the overall structures are quite stable. Because of the stability of the structures, the frame 100 or the molds will not have heat deformation in the heating processes of heat pressing and drying. In other words, the tolerance of the molds will not be affected because of the heat deformation, and the productivity will be improved.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A double molded pulp molding machine, comprising:
a frame having a moving space, a longitudinal section and a transversal section which are connected to each other and overlapped in longitudinal and transversal directions, and the frame being provided with a slurry tank in the longitudinal section corresponding to the moving space;
a longitudinal mechanism disposed in the longitudinal section and corresponding to a top wall of the moving space;
a forming and carrying module including a carrying upper mold driven by the longitudinal mechanism and a forming lower mold being capable of lifting in the slurry tank and clamping and delivering with the carrying upper mold;
a transversal mechanism disposed in the transversal section and corresponding to a bottom wall of the moving space; and
a pair of heat pressing molds, each of the heat pressing molds including a heat pressing upper mold and a heat pressing lower mold driven by the transversal mechanism, the carrying upper mold being capable of clamping and delivering with each heat pressing lower mold, and the heat pressing upper mold being capable of clamping and heat pressing with the heat pressing lower mold;
wherein the time of the forming lower mold delivers pulp productions to the carrying module repeatedly and then the carrying module delivers the pulp productions to each of the heat pressing lower molds is close to or the same as the total time of the heat pressing molds finish heat pressing and drying.

2. The machine according to claim 1, wherein the frame is formed as an integral body.

3. The machine according to claim 1, wherein the longitudinal section and the transversal section are configured in a T-shaped.

4. The machine according to claim 1, wherein the pair of heat pressing molds are disposed in two ends of the transversal section separately, and the longitudinal section is connected between the two ends of the transversal section in overlapping manner.

5. The machine according to claim 1, wherein the carrying upper mold and the heat pressing upper mold are vacuum molds.

6. The machine according to claim 1, wherein the carrying upper mold is provided with a carrying lifting mechanism, and the forming lower mold is provided with a forming lifting mechanism, the forming lower mold is driven by the forming lifting mechanism for clamping with the carrying upper mold, the carrying upper mold is driven by the carrying lifting mechanism for clamping with each of the heat pressing lower molds separately.

7. The machine according to claim 1, wherein the heat pressing upper mold is provided with a heat pressing lifting mechanism, and the heat pressing upper mold is driven by the heat pressing lifting mechanism for clamping with the heat pressing lower molds respectively.

8. The machine according to claim 1, wherein the longitudinal mechanism includes a pair of longitudinal rails and at least one longitudinal lead screw disposed in the longitudinal section of the frame.

9. The machine according to claim 1, wherein the transversal mechanism includes a pair of transversal rails and at least one transversal lead screw disposed in the longitudinal transversal section of the frame.

10. The machine according to claim 1, further including a pair of guiding racks and a pair of trays, the pair of guiding racks being disposed in the transversal section corresponding to the location of the heat pressing molds, and the pair of the trays being disposed separately and driven by the guiding racks.

11. The machine according to claim 10, wherein the pair of guiding racks guides the pair of trays respectively and go back and forth below the heat pressing upper molds in a longitudinal direction.
